(19) United States
(12) Patent Application Publication
(10) Pub. No.: US 2024/0046385 A1
(43) Pub. Date: Feb. 8, 2024

(54) JOURNEY AND CHARGE PRESENTATIONS AT MOBILE DEVICES

(71) Applicant: ENT. SERVICES DEVELOPMENT CORPORATION LP, Houston, TX (US)

(72) Inventors: Kieran MCCORRY, Belfast Antrim (GB); Garry WILSON, Leixlip (IE); Edna CURRAN, Galway (IE)

(73) Assignee: ENT. SERVICES DEVELOPMENT CORPORATION LP, Houston, TX (US)

(21) Appl. No.: 18/490,354

(22) Filed: Oct. 19, 2023

Related U.S. Application Data
(63) Continuation of application No. 17/306,540, filed on May 3, 2021, now abandoned.
Application No. 17/306,540 is a continuation of application No. 15/570,303, filed on Oct. 27, 2017, now abandoned.

(51) Int. Cl. G06Q 50/14; H04W 4/029; G06Q 20/14; G06Q 20/32; G06Q 30/0283; G01C 21/34; G06Q 20/40; G06Q 50/30; G07B 15/00

(52) U.S. Cl. CPC G06Q 50/14; H04W 4/029; G06Q 20/145; G06Q 20/3224; G06Q 20/3274; G06Q 30/0284; G01C 21/34; G06Q 20/3223; G06Q 20/4014; G06Q 20/407; G06Q 50/30; G07B 15/00; G07B 15/02

(57) ABSTRACT

In one example of the disclosure, identify data indicative of identity of a user of a mobile device is obtained. Route data indicative of a set of routes provided by a travel provider is obtained. Movement data indicative of movement of the mobile device is obtained from the mobile device. The movement data was determined utilizing a geolocational recognition component at the mobile device without reference to infrastructure of the travel provider. A journey taken by the user and a charge for the journey are determined based upon the identity data, the movement data, and the route data. Journey data indicative of the journey and charge data indicative of the charge are provided to the mobile device for presentation.

### BACKGROUND

Public transport such as bus and air services are a critical component of modern life. The ability of people to move from place to place for work and for leisure is fundamental to each of the private, public and volunteer economic sectors, and to family life and leisure. Accordingly, issues that affect the quality, affordability, and ease of use of public transport will have significant effect upon local, national, and global economies and human quality of life.

### DRAWINGS

FIG. 1 is a block diagram depicting an example environment in which various examples of the disclosure may be implemented.

FIGS. 2A and 2B are block diagrams depicting examples of a system to enable journey and charge presentations at mobile devices.

FIGS. 3A and 3B are block diagrams depicting a memory resource and a processing resource to implement examples of a system to enable journey and charge presentations at mobile devices

FIGS. 4, 5A, 5B, 6A, and 6B illustrate an example of a system for automated presentation of journeys and charges at mobile devices.

FIG. 7 is a flow diagram depicting implementation of an example of a method for journey and charge presentations at mobile devices.

FIG. 8 is a flow diagram depicting implementation of an example of a method for journey and charge presentations at a mobile device, including utilizing movement data determined by an intrinsic geolocational recognition component of the mobile device.

FIG. 9 is a flow diagram depicting implementation of an example of a method for enabling presentations of journey data and charge data at a mobile device.

### DETAILED DESCRIPTION

INTRODUCTION: When passengers take a journey via public transport with a predefined schedule (e.g., via a train or bus) they often purchase a ticket, e.g., a printed ticket, for that journey in advance. There are several drawbacks to this approach, however. For instance, purchasing a ticket pre-supposes the actual journey that the passenger will take. However, the passenger may finish the journey early, in which case the passenger may have paid too much. On the other hand, a passenger on a given trip may travel further than the ticket permits. In this scenario the passenger may have paid too little for the service provided by the travel provider.

Further, where a travel provider has a system to accommodate changes in travel from that for which a ticket was purchased, such changes can be difficult to administer. As examples, a change in travel plans will frequently require the additional steps of collecting additional payment from or making a refund to the passenger, and as a result such changes can be slow to implement and can involve an administrative change fee. Further, there has been an overhead associated with travel providers' attempts to provide increased flexibility with respect to route charging and ticketing by utilizing expensive specialized travel provider infrastructure such as customized rails, turnstiles, kiosks, electronic checkpoints, and networks maintained or under the control of a travel provider.

To address these issues, various examples described in more detail below provide a system and a method for enabling journey and charge presentations at mobile devices. In an example, identity data indicative of identity of a user of a mobile device is obtained at a computing device hosting a journey and charge presentation system. Route data indicative of a set of routes provided by a travel provider is obtained. In examples, the route data may include both published route data that has been distributed, circulated or advertised regarding the set of routes and operational route data that is real-time, current, or recent information regarding the set of routes that amends, refreshes, or supplements published route data. Movement data indicative of movement of the mobile device (e.g., speed, distance, and direction of movement) is obtained from the mobile device. The movement data is data that was determined utilizing a geolocational recognition component at the mobile device, with the determination made without reference to any infrastructure of the travel provider. A journey taken by the user and a charge for the journey are determined based upon analysis of the identity data, the movement data, and the route data. Journey data indicative of the journey and charge data indicative of the charge are in turn provided to the mobile device for presentation at the mobile device for the benefit of the user.

In examples, the journey data and the charge data are provided for user consumption via an application to execute at the mobile device. In examples, the journey data and the charge data can be provided to an authorized computing device distinct from the mobile device.

In examples, the charge data that was provided to the mobile device includes information regarding the user's payment, or regarding a means for the user to make payment, for the journey. In an example, the charge data provided to the mobile device may include a confirmation of an automatic debit from an account associated with the user or the mobile device. In another example, the charge data provided to the mobile device may include a graphic user interface to enable the user to make payment via the mobile device.

In examples, ticket data indicative of a ticket for the journey may be provided to the mobile device for presentation via the mobile device. The ticket data may be indicative of a ticket to be presented, visually, audibly, via an electronic signal, or otherwise, to a ticket-receiving computing device or to a human being that is to receive or observe the ticket. In examples, the ticket data may be in the form of an image, such as a QR code or other barcode, or in the form of a text or digital passcode.

In examples, an anticipated duration for the journey may be determined based upon the route data, and in determining the charge a discount may be applied or a refund initiated or made based upon a period that the actual duration of the journey exceeded the anticipated duration. In other examples, a recommendation for the user regarding a future journey or a charge for a future journey may be provided to the mobile device for presentation. The recommendation may be determined based upon a stored profile for the user. The profile is a profile accumulated or otherwise created based upon data relating to previous journeys taken by the user along at least one of the routes of the set of routes.

In this manner, the disclosed examples provide for an efficient and easy to use method and system enabling accurate consumption-based charging that should be appreciated by both passengers and travel providers. Examples disclosed herein will promote an enhanced customer experience and ease of customer use of a travel provider's systems and services. The disclosed examples should enable travel providers to provide a differentiated travel experience and services, while improving customer analytics and business intelligence. Further, as examples disclosed herein do not rely upon travel provider infrastructure to track movement of the passenger user's mobile device, these benefits may be enjoyed while reducing costs for travel providers in terms of infrastructure and manpower for operational services.

The following description is broken into sections. The first, labeled “Environment,” describes an environment in which various examples may be implemented. The second section, labeled “Components,” describes examples of various physical and logical components for implementing various examples. The third section, labeled “Illustrative Example,” presents an example of reporting computer resource accesses. The fourth section, labeled “Operation,” describes implementation of various examples.

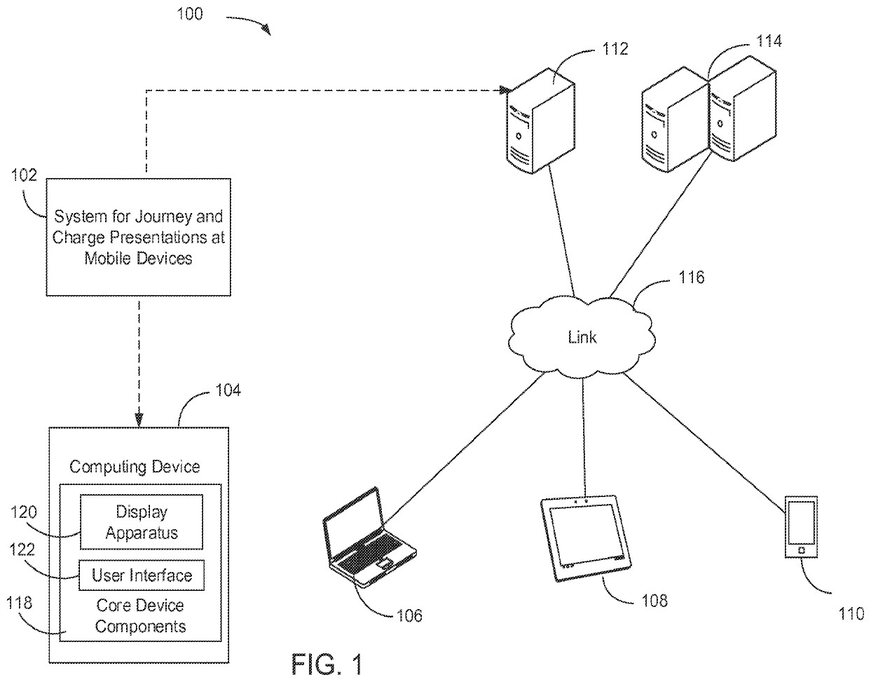

ENVIRONMENT: FIG. 1 depicts an example environment 100 in which examples may be implemented as a system 102 for reporting computer resource accesses. Environment 100 is shown to include computing device 104, client devices 106, 108, and 110, server device 112, and server devices 114. Components 104-114 are interconnected via link 116.

Link 116 represents generally any infrastructure or combination of infrastructures to enable an electronic connection, wireless connection, other connection, or combination thereof, to enable data communication between components 104-114. Such infrastructure or infrastructures may include, but are not limited to, a cable, wireless, fiber optic, or remote connections via telecommunication link, an infrared link, or a radio frequency link. For example, link 116 may represent the internet, intranets, and any intermediate routers, switches, and other interfaces. As used herein an “electronic connection” refers generally to a transfer of data between components, e.g., between two computing devices, that are connected by an electrical conductor. A “wireless connection” refers generally to a transfer of data between two components, e.g., between two computing devices, that are not directly connected by an electrical conductor. A wireless connection may be via a wireless communication protocol or wireless standard for exchanging data.

Client devices 106, 108, and 110 represent generally any computing device with which a user may interact to communicate with other client devices, server device 112, and/or server devices 114 via link 116. Server device 112 represents generally any computing device to serve an application and corresponding data for consumption by components 104-110 and 114. Server devices 114 represent generally a group of computing devices collectively to serve an application and corresponding data for consumption by components 104-110 and 112.

Computing device 104 represents generally any computing device with which a user may interact to communicate with client devices 106-110, server device 112, and/or server devices 114 via link 116. Computing device 104 is shown to include core device components 118. Core device components 118 represent generally the hardware and programming for providing the computing functions for which device 104 is designed. Such hardware can include a processor and memory, a display apparatus 120, and a user interface 122. The programming can include an operating system and applications. Display apparatus 120 represents generally any combination of hardware and programming to exhibit or present a message, image, view, or other presentation for perception by a user, and can include, but is not limited to, a visual, tactile or auditory display. In examples, the display apparatus 120 may be or include a monitor, a touchscreen, a projection device, a touch/sensory display device, or a speaker. User interface 122 represents generally any combination of hardware and programming to enable interaction between a user and device 104 such that the user may effect operation or control of device 104. In examples, user interface 122 may be, or include, a keyboard, keypad, or a mouse. In some examples, the functionality of display apparatus 120 and user interface 122 may be combined, as in the case of a touchscreen apparatus that may enable presentation of images at device 104, and that also may enable a user to operate or control functionality of device 104.

System 102, discussed in more detail below, represents generally a combination of hardware and programming to enable journey and charge presentations at mobile devices. In some examples, system 102 may be wholly integrated within core device components 118. In other examples, system 102 may be implemented as a component of any of computing device 104, client devices 106-110, server device 112, or server devices 114 where it may take action based in part on data received from core device components 118 via link 116. In other examples, system 102 may be distributed across computing device 104, and any of client devices 106-110, server device 112, or server devices 114.

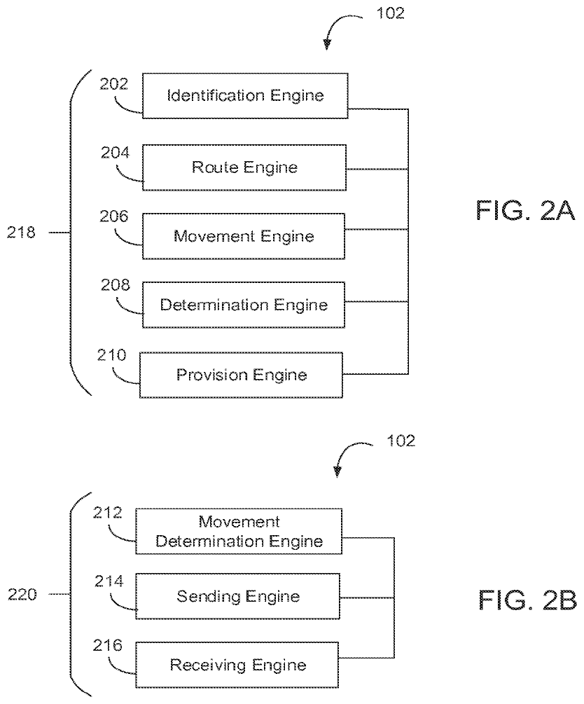

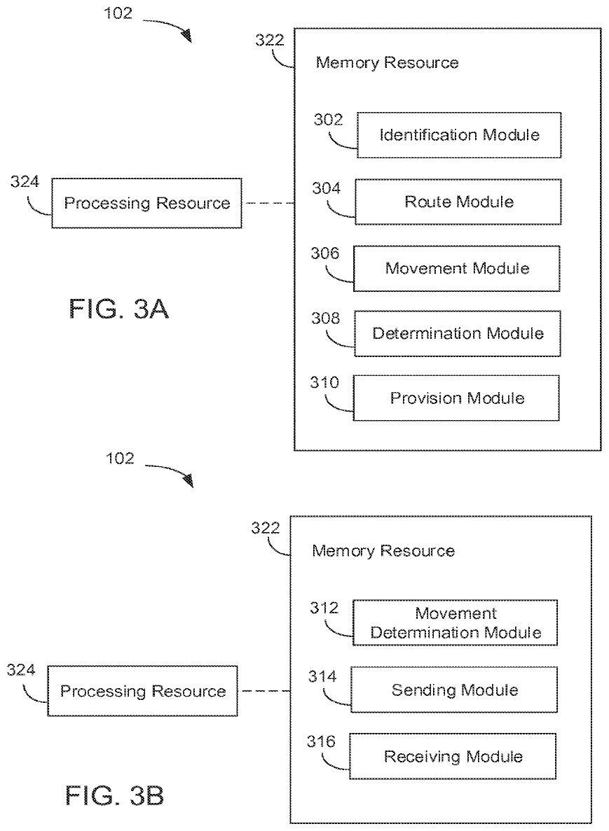

COMPONENTS: FIGS. 2A, 2B, 3A and 3B depict examples of physical and logical components for implementing various examples. In FIGS. 2A and 2B various components are identified as engines 202, 204, 206, 208, 210, 212, 214, and 216. In describing engines 202-216 focus is on each engine's designated function. However, the term engine, as used herein, refers generally to a combination of hardware and programming to perform a designated function. As is illustrated later with respect to FIGS. 3A and 3B, the hardware of each engine, for example, may include one or both of a processor and a memory, while the programming may be code stored on that memory and executable by the processor to perform the designated function.

FIG. 2A is a block diagram depicting components of a system 102 to enable journey and charge presentations at mobile devices. In this example, system 102 includes identification engine 202, route engine 204, movement engine 206, determination engine 208, and provision engine 210. In performing their respective functions, engines 202-210 may access a data repository, e.g., any memory accessible to system 102 that can be used to store and retrieve data. In an example, identification engine 202 represents generally a combination of hardware and programming to obtain identity data that is indicative of identity of a user of a mobile device. As used herein, a “computing device” may be a server, computer networking device, chip set, desktop computer, notebook computer, workstation, tablet computer, smartphone or any other processing device or equipment. The terms “mobile device” and “mobile computing device” are used synonymously, and refers generally to any portable computing device, including, but not limited to, a notebook computer, tablet computer, or smartphone. In examples, the identity data may include a user name and/or a numerical indicator for the user. In examples, the identity data may include billing information for the user of the mobile device, including, but not limited to, a billing address, a telephone number, an email account, and/or an identifier for an online payment system account, bank account, credit card account, or other financial account of the user. In an example, identification engine 202 may obtain the identity data from the mobile device over a network, e.g., link 116. In another example, identification engine may receive device information over the network from the mobile device, and may access a database that stores user profile information in association with mobile device identifiers to obtain the identity data.

Route engine 204 represents generally a combination of hardware and programming to obtain route data indicative of a set of routes provided by a travel provider. As used herein, a “route” refers generally to any way or course for travel from one place to another. In examples, a route may include, but is not limited to, a roadway or a railway. “Route data” and “route information” are used synonymously herein. As used herein, a “travel provider” refers generally to any entity engaged in operating or otherwise providing public transportation. In examples, a travel provider may be an operator of a short or long route bus service, a short or long route train service, or any other public transportation service. In an example, route engine 204 may obtain the route data from a travel provider computer system over a network, e.g., link 116. In another example, identification engine may access a database that stores route information in association with travel provider identities and/or geolocational identifiers to obtain the route data. As used herein, a “geolocational identifier” refers generally to any information that denotes or suggests a geographic location, or a history or progression of geographic locations, including, but not limited to GPS coordinates, longitude and latitude coordinates, WOEIDs (Where on Earth Identifiers), and NAC Locator addresses. As used herein, a “geographic location” refers generally to any site, place, or position on the planet.

In examples, the obtained route data may include both published route data and operational route data. As used herein “published route data” and “published route information” are used synonymously, and refer generally to distributed, circulated or advertised information regarding the set of routes. In an example, published route data may include lists or maps or location coordinates of waypoints supported by a travel provider and associated departure and arrival information. As used herein “operational route data” and “operational route information” are used synonymously and refer generally to real-time, current, or recent information regarding the set of routes that may amend, refresh, or supplement published route data. In examples, operational route data may include changes to the set of routes. In other examples, operational route data may include changes to published departure and arrival information, such as times and assigned boarding gates. In another example, operational route data may include historical timestamp information associated with the travel provider's previous provision of travel between the waypoints. As used herein, a “timestamp” refers generally to a sequence of characters or encoded information identifying when a certain event occurs, e.g., a transport reaching or passing a travel milestone or destination. For instance, timestamp information may include year, date, and time of day information for times that a rail transport reaches designated stops or access/egress points along a route. In another example, operational route data may include changes to published route data to reflect additions or deletions of waypoints of a route.

Continuing with the example of FIG. 2A, movement engine 206 represents generally a combination of hardware and programming to obtain from the mobile device movement data indicative of movement of the mobile device. In examples, the movement data can include, but is not limited to, data indicative of speed, distance, and direction of movement of the mobile device. The movement data is determined utilizing a geolocational recognition component at the mobile device, without reference to any infrastructure of the travel provider. As used herein, a “geolocational recognition component” refers generally to any combination of hardware and programming to enable a mobile device to determine its geographic location, or a history or progression of geographic locations. As used herein, “infrastructure of a travel provider” or “travel provider infrastructure” refers generally to any transportation materials, components, or systems that are maintained or under the control of a travel provider. Examples of travel provider infrastructure may include, but are not limited to transports, rails, stations, private roads, turnstiles, kiosks, electronic checkpoints, computer systems, software, and networks maintained or under the control of a travel provider. A geolocational recognition component that is utilized to determine movement data without reference to infrastructure of the travel provider is sometimes referred to herein as an “intrinsic geolocational recognition component.” In examples, an intrinsic geolocational recognition component may include programming to enable a mobile device to determine its geographic location or progress along a route via communication with a global positioning service (“GPS”), or via communication over a short-range or local area wireless computer network, where neither the GPS service nor the network are travel provider infrastructure.

In one example, the geolocational recognition component at the mobile device may determine geographic coordinates for the location, or a series of locations, for the mobile device and determine the movement data itself. In this example, movement engine 206 may obtain via a network, e.g., link 116, the movement data from the movement analytics computing device.

In a second example, the geolocational recognition component at the mobile device may determine geographic coordinates for the location, or a series of locations, for the mobile device, and a movement analytics server may obtain the coordinates information to determine the movement data. In this second example, movement engine 206 may obtain the movement data from the movement analytics server via a network, e.g., link 116.

Determination engine 208 represents generally a combination of hardware and programming to determine a journey taken by the user and a charge for the journey based upon the identity data, the movement data, and the route data. As used herein, a “journey” is used synonymously with “trip”, and refers to a course along route or routes taken or being taken by a user in a particular outing to travel from a first location to a second location. In examples, a journey may be a user's course along a single route provided by a travel provider, a user's course along multiple routes provided by a travel provider, or may be a user's course along routes of multiple travel providers (e.g., a journey that includes a combination of a route of a railway travel provider and a route of a bus travel provider). In an example, determination engine 208 may access a journeys database that stores information regarding a user's current journey and routes taken as part of that current journey, to be used as historical information or profile information for future journeys by that user or other users. As used herein, a “charge” refers generally to an amount to be paid as a price or fare for something, e.g., a product supplied or a service rendered. In an example, a charge for a journey is an amount to be paid as a price or fare by a user to a travel provider for the travel provider's provision of a transport or other goods or services in connection with the journey.

In an example, determination engine 208 may determine the charge based upon a type of carriage or seat of a transport that the user traveled in. In particular example, determination engine 208 may determine the type of carriage or seat by comparing the movement data for the mobile device with movement data for a target reference in the transport. For instance, determination engine 208 may access transport setup data indicative that the transport that the user is traveling in has a transport-tracker computing device affixed at the front of the transport, and that a first class carriage of the transport has a length extending 20 meters through 35 meters from the affixed transport tracker device. Determination engine 208 may track movement of the user's mobile device relative to movement of the transport-tracker device ascertain that the user is riding in the first class carriage. For instance, if determination engine 208 detects that the user's mobile device and the transport-tracker device are traveling at a same speed along a published route and with a consistent or nearly consistent distance of 25 meters separating them, determination engine 208 may determine that the user is riding in the first class carriage. Conversely, in an example if determination engine 208 detects that the user's mobile device and the transport-tracker device are traveling at a same speed along a published route and with a consistent or nearly consistent distance of 40 meters separating them, in this example determination engine 208 may determine that the user is riding in a carriage of the transport that is not a first class carriage, e.g., a coach or business class carriage.

Provision engine 210 represents generally a combination of hardware and programming to provide to the mobile device, for presentation at the mobile device, journey data indicative of the journey and charge data indicative of the charge. In an example, provision engine 210 is to provide the journey data and the charge data for user consumption via an application to execute at the mobile device.

In an example, provision engine 210 may include an application programming interface to provide the journey data and the charge data to an authorized computing device distinct from the mobile device. In this manner, computing devices and systems other than the user's mobile device may be given access to the journey data and the charge data. In a particular example, provision engine 210 may include an application programming interface to provide the journey data and the charge data to a trip compiler computing device that utilizes the journey data and the charge data to generate or amend published route data and/or operational route data for one or more travel providers' routes. In another particular example, provision engine 210 may include an application programming interface to provide the journey data and the charge data to a profile management computing device that utilizes the journey data and the charge data to create, edit, and/or store user travel profiles and other user profiles.

In an example, provision engine 210 may utilize billing information for the user of the mobile device, e.g., billing information obtained by identification engine 202 as identity data, to implement automatic payment of charges indicated by the charge data. For instance, automatic payment may be the result of the user of the mobile device having instructed the mobile device and/or system 102 to automatically pay charges indicated by the charge data utilizing funds of a financial account designated by the user. In this example, the charge data provided to the mobile device by provision engine 210 may include a confirmation of an automatic debit from an account associated with the user or the mobile device.

In another example, the user of the mobile device may not have set up an automatic payment system, and the charge data provided to the mobile device by the provision engine may include a graphic user interface to enable the user to make payment via the mobile device. As used herein, “graphic user interface” and “GUI” are used synonymously, and refer generally to any type of display caused by an application that can enable a user to interact with the application via visual properties of the display. In examples the GUI may include be or include, but is not limited to, an interactive text field, a list box, a check box, a dropdown list, an interactive button, a table control, and/or another interface. For instance, the provided GUI may be a GUI to enable the user at the mobile device to enter credit card information or other payment information at the GUI to pay for the journey as indicated by the charge data.

In an example, provision engine 210 may provide to the mobile device ticket data indicative of a ticket for the journey. In an example, the ticket is sent to the mobile device the purpose of being presented via the mobile device to a ticket receiver computer system, or alternatively to a human ticket reader. As used herein, a “ticket” refers generally to a presentable indicia that the user of the mobile device is authorized to make the journey on the transport. In a particular example, the ticket is in the form of an image that is to be displayed via the mobile device. As used herein, “display” refers generally to exhibition or presentation caused by a computer for the purpose of perception by a user. In examples, a display may be a display to be presented at a computer monitor, touchscreen, projection device, or other electronic display device. As used herein, a “display device” refers generally to any combination of hardware and programming configured to exhibit or present the message or other information for perception by a user, and can include, but is not limited to, a visual, tactile or auditory display. In particular examples, the ticket may be in form of a barcode, e.g., a two-dimensional barcode such as a QR Code. In other examples, the ticket may be in the form of a text or digital passcode.

In an example in which an application executes at the mobile device to provide the journey data and the charge data for user consumption at the mobile device, movement engine 204 is to obtain the movement data and provision engine 210 is to provide the journey data and the charge data without any requirement of user interaction with the application. Thus, in this example, journey and charge presentation is to occur at the mobile device in an automated manner.

In a particular example, in order to implement automated journey and charge presentation, determination engine 208 may determine a starting point for the journey based upon movement data indicative of a proximity event or an itinerary event. As used herein, a “proximity event” refers generally to a detected occurrence of the mobile device having traversed within a predetermined distance of a target location described in the route data. For instance, as opposed to requiring a user interaction with an application executing at the mobile device or other user activity to indicate the beginning of a journey, in this example determination engine 208 may determine the beginning of a journey based upon the user's mobile device coming within 15 meters of a target milestone along the route, e.g., GPS coordinates know to be associated with a train station or bus station. In an example, the predetermined distance may be included within the route data. As used herein, an “itinerary event” refers generally to a proximity event that is to occur within a predetermined time period. For instance, as opposed to requiring a user interaction with an application executing at the mobile device or other user activity to indicate the beginning of a journey, in this example determination engine 208 may determine the beginning of a journey based upon the user's mobile device coming within a predefined distance of 15 meters of a target milestone along the route, e.g., GPS coordinates know to be associated with a train station or bus station, within a prescribed time period, e.g., between 07:30 a.m. and 08:30 a.m. In an example, the predetermined distance and/or the time period may be included within the route data.

In an example, determination engine 208 is to analyze the journey to ascertain whether the journey was a success in terms of meeting a predefined anticipated journey duration target, and may reduce the charge or cause a refund to be issued to the user if the journey did not meet the goal or benchmark. In a particular example, determination engine 208 is to determine an anticipated duration for the journey based upon the route data and is to, in determining the charge, apply a discount or initiate a refund responsive to a determination that an actual duration of the journey exceeds the target anticipated duration.

In another example, provision engine 210 may access a stored profile for the user of the mobile device, wherein the profile was created based upon data relating to previous journeys taken by the user along at least one of the routes of the set of routes, and determine a recommendation regarding a future journey, or a charge for a future journey, for the user based upon the profile. In this example, provision engine 210 may provide the recommendation to the mobile device for presentation to the user at the mobile device. For instance, provision engine 210 may access a database with a profile for the user of the mobile device, the profile indicating the user takes the same train on a same route on average seven times a month and pays a daily rate for the train. In this instance, provision engine 210 may provide a recommendation to the mobile device for presentation to the user, the recommendation suggesting the user purchase a monthly ticket that will be less expensive for the user as compared to the user's current practice of purchasing tickets at the daily rate.

In examples, identification engine 202 may obtain the identity data, route engine 204 may obtain route data, movement engine 206 may obtain the movement data from the mobile device, and/or the provision engine may provide the journey data and the charge data to the mobile device over a link 116 via a networking protocol. In examples the networking protocol may include, but is not limited to, Transmission Control Protocol/Internet Protocol (“TCP/IP”), HyperText Transfer Protocol (“HTTP”), and/or Session Initiation Protocol (“SIP”).

FIG. 2B is a block diagram depicting components of a system 102 to enable journey and charge presentations at mobile devices. In this example, system 102 includes movement determination engine 212, sending engine 214, and receiving engine 216. In performing their respective functions, engines 212-216 may access a data repository, e.g., any memory accessible to system 102 that can be used to store and retrieve data. In an example, movement determination engine 212 represents generally a combination of hardware and programming to utilize a geolocational recognition component of a mobile device to determine movement data without reference to infrastructure of a travel provider. The movement data is indicative of movement of the mobile device, e.g., speed data, distance data, and movement direction data.

Sending engine 214 represents generally a combination of hardware and programming to utilize a network communication component of the mobile device to send the movement data and identity data indicative of identity of a user of the mobile device to a trip analytics computing device. The trip analytics device is to obtain route data regarding a set of routes provided by the travel provider. Further, the trip analytics device is to determine a journey taken by the user and a charge for the journey based upon the identity data, the movement data, and the route data.

Continuing with the example of FIG. 2B, receiving engine 216 represents generally a combination of hardware and programming to receive from the trip analytics device, for presentation at the mobile device, journey data indicative of the journey and charge data indicative of the charge for the journey. In examples, the receiving engine additionally receives a ticket for the journey. In this manner, a user of the mobile device can benefit from automated tracking of movement of the mobile device and the user and consumption-based charging for the journey without reliance upon travel-provider infrastructure.

With reference back to FIG. 1 in view of FIGS. 2A and 2B, in one example system 102 may include a journey and charge service component 218 that includes engines 202-210 operating on server device 112 (or one or more other devices shown or not shown in FIG. 1) and/or a client component 220 that includes engines 212-216 operating on client device 106 (or one or more other devices not shown in FIG. 1). In other examples, system 102 may include engines 202-210 and/or engines 212-216 included within, or distributed across, any one or several of computing device 104, client devices 106-110, server device 112, or server devices 114.

In the foregoing discussion of FIGS. 2A and 2B, engines 202-216 were described as combinations of hardware and programming. Engines 202-216 may be implemented in a number of fashions. Looking at FIGS. 3A and 3B the programming may be processor executable instructions stored on a tangible memory resource 322 and the hardware may include a processing resource 324 for executing those instructions. Thus memory resource 322 can be said to store program instructions that when executed by processing resource 324 implement system 102 of FIGS. 2A and 2B.

Memory resource 322 represents generally any number of memory components capable of storing instructions that can be executed by processing resource 324. Memory resource 322 is non-transitory in the sense that it does not encompass a transitory signal but instead is made up of more or more memory components to store the relevant instructions. Memory resource 322 may be implemented in a single device or distributed across devices. Likewise, processing resource 324 represents any number of processors capable of executing instructions stored by memory resource 322. Processing resource 324 may be integrated in a single device or distributed across devices. Further, memory resource 322 may be fully or partially integrated in the same device as processing resource 324, or it may be separate but accessible to that device and processing resource 324.

In one example, the program instructions can be part of an installation package that when installed can be executed by processing resource 324 to implement system 102. In this case, memory resource 322 may be a portable medium such as a CD, DVD, or flash drive or a memory maintained by a server from which the installation package can be downloaded and installed. In another example, the program instructions may be part of an application or applications already installed. Here, memory resource 322 can include integrated memory such as a hard drive, solid state drive, or the like.

In FIG. 3A, the executable program instructions stored in memory resource 322 are depicted as identification module 302, route module 304, movement module 306, determination module 308, and provision module 310. Identification module 302 represents program instructions that when executed by processing resource 324 may perform any of the functionalities described above in relation to identification engine 202 of FIG. 2A. Route module 304 represents program instructions that when executed by processing resource 324 may perform any of the functionalities described above in relation to route engine 204 of FIG. 2A. Movement module 306 represents program instructions that when executed by processing resource 324 may perform any of the functionalities described above in relation to movement engine 206 of FIG. 2A. Determination module 308 represents program instructions that when executed by processing resource 324 may perform any of the functionalities described above in relation to determination engine 208 of FIG. 2A. Provision module 310 represents program instructions that when executed by processing resource 324 may perform any of the functionalities described above in relation to provision engine 210 of FIG. 2A.

In FIG. 3B, the executable program instructions stored in memory resource 322 are depicted as movement determination module 312, sending module 314, and receiving module 316. Movement determination module 312 represents program instructions that when executed by processing resource 324 may perform any of the functionalities described above in relation to movement determination engine 212 of FIG. 2B. Sending module 314 represents program instructions that when executed by processing resource 324 may perform any of the functionalities described above in relation to sending engine 214 of FIG. 2B. Receiving module 316 represents program instructions that when executed by processing resource 324 may perform any of the functionalities described above in relation to receiving engine 216 of FIG. 2B.

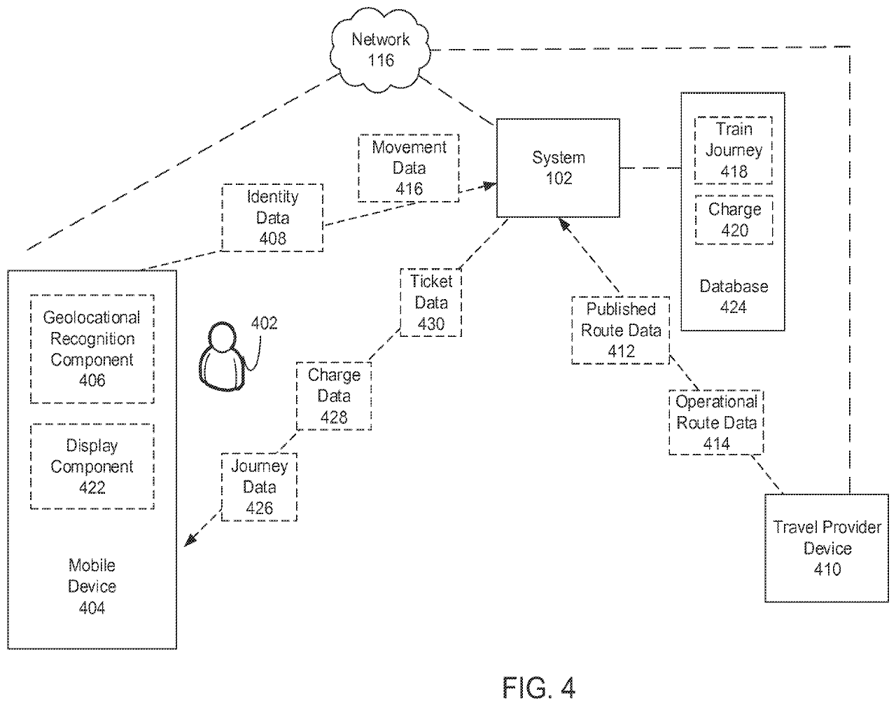

ILLUSTRATIVE EXAMPLE: FIGS. 4, 5A, 5B, 6A, and 6B, in view of FIGS. 1, 2A, and 2B, illustrate an example of a system 102 for automated presentation of journeys and charges at mobile devices. In examples, system 102 may be hosted at a computing device such as server device 112 (FIG. 1) or distributed over a set of computing devices such as server system 114 (FIG. 1). Beginning at FIG. 4, in this example, a user 402 carries a smartphone or other mobile device 404, the mobile device including a geolocational recognition component 406. In this example, system 102 hosts an automated journey ticketing mobile web application that is user accessible at the mobile device 404. In this example, the mobile web application runs in the background at the mobile device 404, and system 102 obtains from the mobile device 404 identity data 408 for the user 402. In examples, the identity data 408 may include a user name, login name, given name, or other identifier for the user 402. In examples the identity data 408 may include billing data for the user, such as a billing address, a telephone number, an email account, and/or an identifier for an online payment system account, bank account, credit card account, or other financial account of the user 402.

Continuing at FIG. 4, in this example system 102 obtains from a travel provider computing device 410 via the network 116 published route data 412 and operational route data 414 regarding routes provided by a set of travel providers, the set including train routes provided by a train travel provider. In this example, the published route data 412 includes information regarding a set of routes that is generally distributed, circulated or advertised by the set of travel providers. In this example, the published route data 412 include lists or maps or location coordinates of waypoints supported by the train travel provider and associated departure and arrival information.

In this example, the operational route data 414 includes real-time or current information, or information for a time period, regarding the set of routes that amends, refreshes, or supplements the published route data 412. In this example, the operational route data 414 includes historical timestamp information associated with the train travel provider's train, e.g., a same train or similar train, previously traversing between waypoints of the route.

Continuing at FIG. 4, system 102 obtains from the mobile device 404, via network 116, movement data 416 indicative of speed, distance, and direction of movement of the mobile device 404. In this example the movement data 416 was determined by the mobile device 404 utilizing the intrinsic geolocational recognition component 406 of the mobile device. The mobile device utilizes the geolocational recognition component 406 to determine the movement data 416 without utilizing the locational coordinates for, sensing, or communicating with any specialized travel provider infrastructure such as customized rails, turnstiles, kiosks, electronic checkpoints, or networks. In an example, the mobile device 404 may utilize the geolocational recognition component 406 to determine the movement data 416 based upon coordinate information determined utilizing signals received from GPS satellites. In another example wherein the mobile phone does not receive or interpret satellite signals, the mobile device 404 may utilize the geolocational recognition component 406 to determine the movement data 416 based upon coordinate information received, via the network 116, by the geolocational recognition component 406 from a GPS computing device that hosts a GPS service, wherein the GPS service receives and interprets positioning based upon satellite signals.

Continuing at FIG. 4, system 102 determines a train journey 418 taken by the user 402 of the mobile device 404 and determines a charge 420 for the train journey 418 in consideration of the identity data 408 for the user 402, the movement data 416 indicative of movement of the mobile device 404 along a train route, and the published route data 412 and the operational route data 414 indicative of the train route. In this example, system 102 in turn causes the determined train journey 418 and the charge 420 to be stored in association with one another at a database 424.

Continuing at FIG. 4, system 102 provides, via the network 116, to the mobile device 404 for presentation at a display component 422 (e.g., a touchscreen) of the mobile device 404, journey data 426 indicative of the determined train journey 418, charge data 428 indicative of the determined charge 420, and ticket data 430 indicative of an electronic ticket that authorizes the user 402 to make the journey via a train and train route provided by the train travel provider.

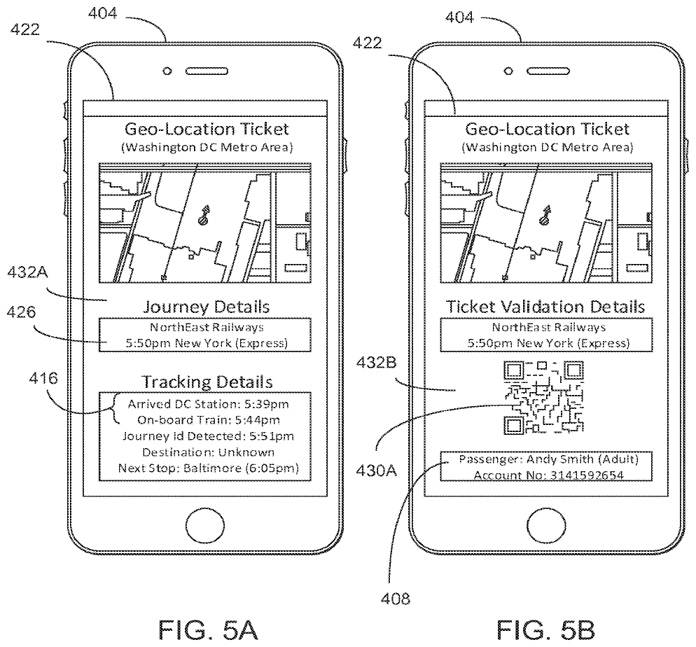

Moving to FIG. 5A in view of FIG. 4, in this example the mobile device 404 includes, presented at a display component 422 of the mobile device, a display 432A of some or all of the received train journey data 426, the display 432A occurring as part of a mobile web application hosted by system 102 and accessed by the mobile device 404. In this example the display 432A includes journey data 426 indicative that a journey began at 5:50 pm on a NorthEast Railways express route. The display 432A also includes movement data 416 indicative that the user 402 and the mobile device 404 arrived at a DC Station at 5:39 pm and the user boarded the train at 5:44 pm, and that the journey 418 was determined at 5:51 pm. In this example, the journey 418 is identified by system 102 and displayed at mobile device 404 prospectively notwithstanding that the destination for the user 402 and mobile device 404 are unknown, as journey tracking automatically began at the mobile device 404 as a proximity or itinerary event, without the user interacting with the application to start journey tracking or to indicate a destination. System 102 may access published route data 412 and/or operational route data 414 to determine a prospective destination (Baltimore), and send this information as “Next Stop” information to the mobile device 404.

Moving to FIG. 5B in view of FIG. 4, in this example the display 432B at the mobile device 404 includes ticket data 430A indicative of a QR code image ticket for the yet to be finalized journey on the train, and includes identity data 408 for the user. In this example, the identity data includes the user's name “Andy Smith” and a credit card account number that will be used for payment. The display 432B of FIG. 5B could be presented to a human or a computing device for validation. At this point in this example no charge data is included in the display as the final destination is still unknown.

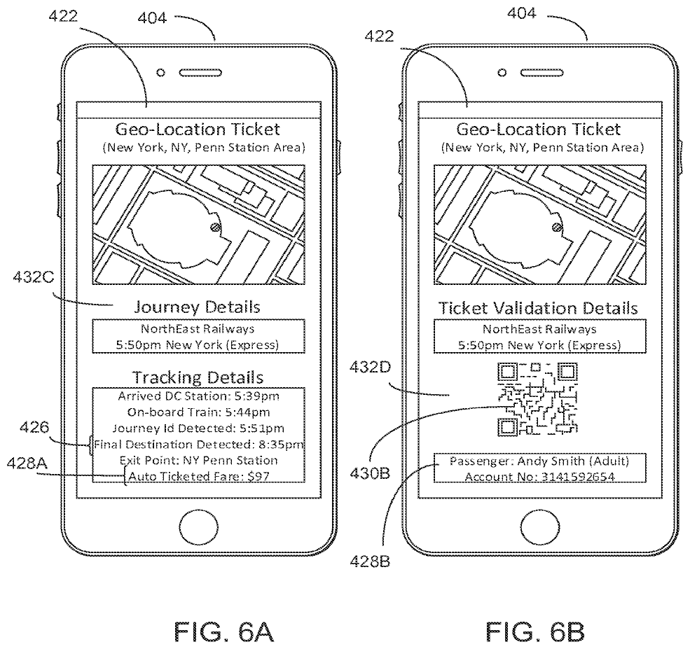

Moving to FIG. 6A in view of FIG. 4, in this example the display 432C at the mobile device 404 now includes journey data 426 indicative that a final destination for the journey was identified by system 102 at 8:35 pm. The final destination is “NY Penn Station.” In this example, system 102 may have determined the final destination by analyzing the movement data 416 and the published route data 412 and the operational route data 414 to determine that the user 402 and the mobile device 404 are no longer traveling along the train's published route, but rather are now traveling at a speed and in one or more directions indicating the user 402 has walked away from the train and/or has boarded another type vehicle, e.g., a personal automobile. The display includes charge data 428A indicative that the fare for the determined train journey from DC Station to NY Penn Station is $97.00.

Moving to FIG. 6B in view of FIG. 4, in this example the display 432D at the mobile device 404 now includes ticket data 430B indicative of a QR code image ticket authorizing the user's travel on this train route. At this point the ticket is for a known destination (from DC Station to NY Penn Station), and is for presentation to a human or a ticket-sensing computing device for validation. At this point, the display 432D includes charge data 428B received from system 102 indicative that the $97.00 fare identified in the display of FIG. 6A has been automatically paid utilizing credit card account “Account No. 3141592654” that system 102 receives from the mobile device 404 as identity data 408. In summary, in this example of FIGS. 4, 5A, 5B, 6A, and 6C, system 102 obtained the movement data 416, and in turn, provided to the mobile device 404 the journey data 426 and the charge data 428A and 428B, without any requirement of user interaction with the application to initiate journey tracking.

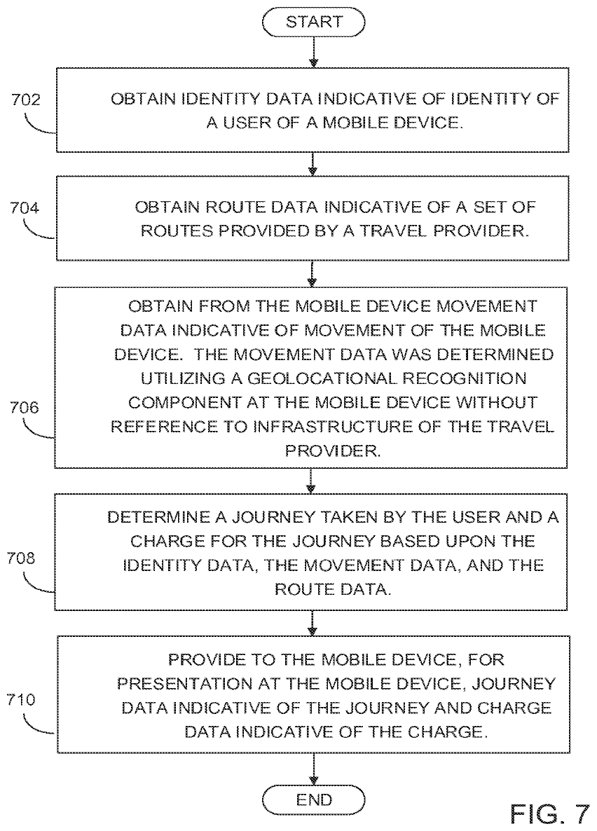

OPERATION: FIG. 7 is a flow diagram of implementation of a method for journey and charge presentations at mobile devices. In discussing FIG. 7, reference may be made to the components depicted in FIGS. 2A and 3A. Such reference is made to provide contextual examples and not to limit the manner in which the method depicted by FIG. 7 may be implemented. Identity data indicative of identity of a user of a mobile device is obtained (block 702). Referring back to FIGS. 2A and 3A, identification engine 202 (FIG. 2A) or identification module 302 (FIG. 3A), when executed by processing resource 324, may be responsible for implementing block 702.

Route data indicative of a set of routes provided by a travel provider is obtained (block 704). Referring back to FIGS. 2A and 3A, route engine 204 (FIG. 2A) or route module 304 (FIG. 3A), when executed by processing resource 324, may be responsible for implementing block 704.

Movement data indicative of movement of the mobile device is obtained from the mobile device. The movement data was determined utilizing a geolocational recognition component at the mobile device without reference to infrastructure of the travel provider (block 706). Referring back to FIGS. 2A and 3A, movement engine 206 (FIG. 2A) or movement module 306 (FIG. 3A), when executed by processing resource 324, may be responsible for implementing block 706.

A journey taken by the user and a charge for the journey are determined based upon the identity data, the movement data, and the route data (block 708). Referring back to FIGS. 2A and 3A, determination engine 208 (FIG. 2A) or determination module 308 (FIG. 3A), when executed by processing resource 324, may be responsible for implementing block 708.

Journey data indicative of the journey and charge data indicative of the charge are provided to the mobile device for presentation at the mobile device (block 710). Referring back to FIGS. 2A and 3A, provision engine 210 (FIG. 2A) or provision module 310 (FIG. 3A), when executed by processing resource 324, may be responsible for implementing block 710.

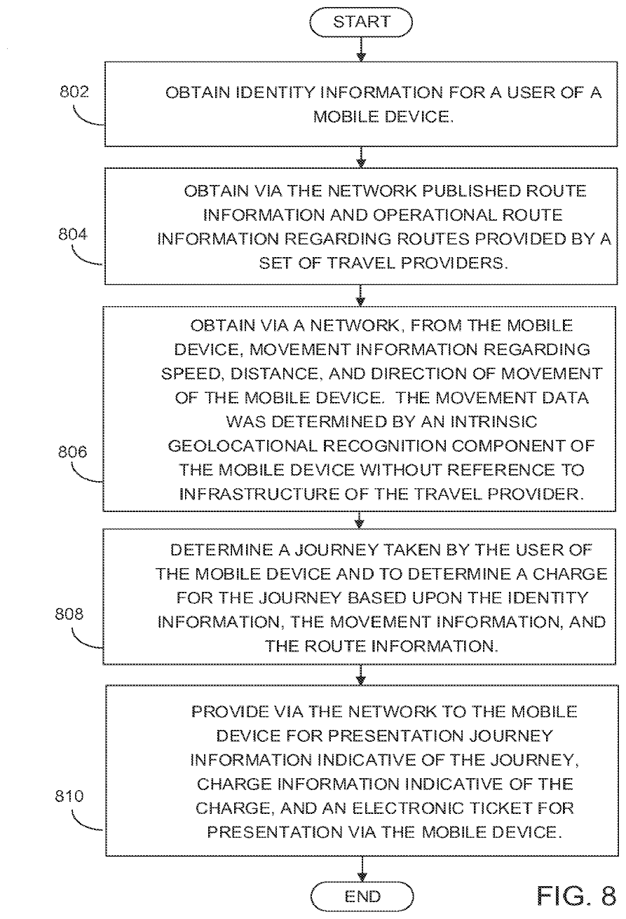

FIG. 8 is a flow diagram of implementation of a method for journey and charge presentations at a mobile device, including utilizing movement data determined by an intrinsic geolocational recognition component of the mobile device. In discussing FIG. 8, reference may be made to the components depicted in FIGS. 2A and 3A. Such reference is made to provide contextual examples and not to limit the manner in which the method depicted by FIG. 8 may be implemented. Identity information for a user of a mobile device is obtained (block 802). Referring back to FIGS. 2A and 3A, identification engine 202 (FIG. 2A) or identification module 302 (FIG. 3A), when executed by processing resource 324, may be responsible for implementing block 802.

Published route information and operational route information regarding routes provided by a set of travel providers are obtained (block 804). Referring back to FIGS. 2A and 3A, route engine 204 (FIG. 2A) or route module 304 (FIG. 3A), when executed by processing resource 324, may be responsible for implementing block 804.

Movement information regarding speed, distance, and direction of movement of the mobile device is obtained from the mobile device via a network. The movement data was determined by an intrinsic geolocational recognition component of the mobile device without reference to infrastructure of the travel provider (block 806). Referring back to FIGS. 2A and 3A, movement engine 206 (FIG. 2A) or movement module 306 (FIG. 3A), when executed by processing resource 324, may be responsible for implementing block 806.

A journey taken by the user of the mobile device is determined and a charge for the journey is determined based upon the identity information, the movement information, and the route information (block 808). Referring back to FIGS. 2A and 3A, determination engine 208 (FIG. 2A) or determination module 308 (FIG. 3A), when executed by processing resource 324, may be responsible for implementing block 808.

Journey information indicative of the journey, charge information indicative of the charge, and an electronic ticket for presentation via the mobile device are provided via the network to the mobile device for presentation (block 810). Referring back to FIGS. 2A and 3A, provision engine 210 (FIG. 2A) or provision module 310 (FIG. 3A), when executed by processing resource 324, may be responsible for implementing block 810.

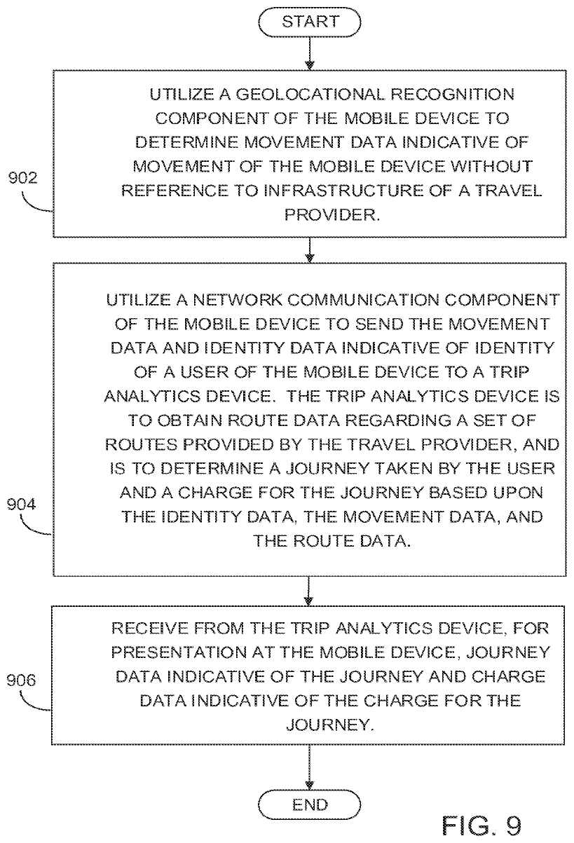

FIG. 9 is a flow diagram of implementation of a method for enabling presentations of journey data and charge data at a mobile device. In discussing FIG. 9, reference may be made to the components depicted in FIGS. 2B and 3B. Such reference is made to provide contextual examples and not to limit the manner in which the method depicted by FIG. 9 may be implemented. A geolocational recognition component of the mobile device is utilized to determine movement data indicative of movement of the mobile device without reference to infrastructure of a travel provider (block 902). Referring back to FIGS. 2B and 3B, movement determination engine 212 (FIG. 2B) or movement determination module 312 (FIG. 3B), when executed by processing resource 324, may be responsible for implementing block 902.

A network communication component of the mobile device is utilized to send the movement data and identity data indicative of identity of a user of the mobile device to a trip analytics device. The trip analytics device is to obtain route data regarding a set of routes provided by the travel provider, and is to determine a journey taken by the user and a charge for the journey based upon the identity data, the movement data, and the route data (block 904). Referring back to FIGS. 2B and 3B, sending engine 214 (FIG. 2B) or sending module 314 (FIG. 3B), when executed by processing resource 324, may be responsible for implementing block 904.

Journey data indicative of the journey and charge data indicative of the charge for the journey, for presentation at the mobile device, is received from the trip analytics device (block 906). Referring back to FIGS. 2B and 3B, receiving engine 216 (FIG. 2B) or receiving module 316 (FIG. 3B), when executed by processing resource 324, may be responsible for implementing block 906.

CONCLUSION: FIGS. 1-9 aid in depicting the architecture, functionality, and operation of various examples. In particular, FIGS. 1, 2A, 2B, 3A, and 3B depict various physical and logical components. Various components are defined at least in part as programs or programming. Each such component, portion thereof, or various combinations thereof may represent in whole or in part a module, segment, or portion of code that comprises executable instructions to implement any specified logical function(s). Each component or various combinations thereof may represent a circuit or a number of interconnected circuits to implement the specified logical function(s). Examples can be realized in any memory resource for use by or in connection with processing resource. A “processing resource” is an instruction execution system such as a computer/processor based system or an ASIC (Application Specific Integrated Circuit) or other system that can fetch or obtain instructions and data from computer-readable media and execute the instructions contained therein. A “memory resource” is any non-transitory storage media that can contain, store, or maintain programs and data for use by or in connection with the instruction execution system. The term “non-transitory” is used only to clarify that the term media, as used herein, does not encompass a signal. Thus, the memory resource can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagrams of FIGS. 7-9 show specific orders of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present disclosure.

The present disclosure has been shown and described with reference to the foregoing examples. It is to be understood, however, that other forms, details and examples may be made without departing from the spirit and scope of the invention that is defined in the following claims. All of the features disclosed in this specification (including any accompanying claims, abstract and drawings), and/or all of the blocks or stages of any method or process so disclosed, may be combined in any combination, except combinations where at least some of such features, blocks and/or stages are mutually exclusive.

What is claimed is:

1. A system, comprising:
an identification engine, to obtain identity data indicative of identity of a user of a mobile device;
a route engine, to obtain route data indicative of a set of routes provided by a travel provider;
a movement engine, to obtain from the mobile device movement data indicative of movement of the mobile device, wherein the movement data was determined utilizing a geolocational recognition component at the mobile device without reference to infrastructure of the travel provider;
a determination engine, to determine a journey taken by the user and a charge for the journey based upon the identity data, the movement data, and the route data; and
a provision engine, to provide to the mobile device for presentation at the mobile device journey data indicative of the journey and charge data indicative of the charge.

2. The system of claim 1, wherein the route data includes published route data and operational route data.

3. The system of claim 1, wherein the movement data includes data indicative of speed, distance, and direction of movement of the mobile device.

4. The system of claim 1, wherein the provision engine is to provide to the mobile device ticket data indicative of a ticket for presentation via the mobile device.

5. The system of claim 1, wherein the charge data includes a confirmation of an automatic debit from an account associated with the user or the mobile device, or includes a GUI to enable the user to make payment via the mobile device.

6. The system of claim 1, wherein the provision engine is to provide the journey data and the charge data for user consumption via an application to execute at the mobile device.

7. The system of claim 1, wherein the provision engine may include an application programming interface to provide the journey data and the charge data to an authorized computing device distinct from the mobile device.

8. The system of claim 6, wherein the movement engine is to obtain the movement data, and the provision engine is to provide the journey data and charge data without any requirement of user interaction with the application to initiate journey tracking.

9. The system of claim 1, wherein the determination engine is to determine a starting point or an ending point for the journey based upon movement data indicative of an itinerary event or a proximity event.

10. The system of claim 1, wherein the determination engine is to determine an anticipated duration for the journey based upon the route data and is to, in determining the charge, apply a discount or initiate a refund based upon actual duration of the journey exceeding the anticipated duration.

11. The system of claim 1, wherein the provision engine is to determine a recommendation for the user regarding a future journey or a charge for a future journey based upon a stored profile for the user, the profile having been created based upon data relating to previous journeys taken by the user along at least one of the routes of the set of routes, and is to provide the recommendation to the mobile device for presentation at the mobile device.

12. A memory resource storing instructions that when executed cause a processing resource to enable presentations of journey data, charge data, and an electronic ticket at a mobile device, the instructions comprising:
an identification module, that when executed causes the processing resource to obtain identity information for a user of the mobile device;
a route module, that when executed causes the processing resource to obtain via a network published route information and operational route information regarding routes provided by a set of travel providers;
a movement module, that when executed causes the processing resource to obtain via the network, from the mobile device, movement information regarding speed, distance, and direction of movement of the mobile device, wherein the movement data was determined by an intrinsic geolocational recognition component of the mobile device without reference to infrastructure of the travel provider;
a determination module, that when executed causes the processing resource to determine a journey taken by the user of the mobile device and to determine a charge for the journey based upon the identity information, the movement information, and the route information; and
a provision module, that when executed causes the processing resource to provide via the network to the mobile device for presentation journey information indicative of the journey, charge information indicative of the charge, and an electronic ticket for presentation via the mobile device.

13. The memory resource of claim 12, wherein the charge is determined based upon a type of carriage or seat of a transport that the user traveled in, and wherein the type is determined by comparing the movement data for the mobile device with movement data for a target reference in the transport.

14. A method for enabling presentations of journey data and charge data at a mobile device, comprising:
utilizing a geolocational recognition component of the mobile device to determine movement data indicative of movement of the mobile device without reference to infrastructure of a travel provider;
utilizing a network communication component of the mobile device to send the movement data and identity data indicative of identity of a user of the mobile device to a trip analytics device,
wherein the trip analytics device is to obtain route data regarding a set of routes provided by the travel provider, and is to determine a journey taken by the user and a charge for the journey based upon the identity data, the movement data, and the route data; and
receiving from the trip analytics device, for presentation at the mobile device, journey data indicative of the journey and charge data indicative of the charge for the journey.

15. The method of claim 14, further comprising receiving from the trip analytics device, for presentation at the mobile device, ticket data indicative of a ticket for the journey.
